(19) United States
(12) Patent Application Publication
(10) Pub. No.: US 2023/0164423 A1
(43) Pub. Date: May 25, 2023

(54) DYNAMIC ADJUSTMENT OF A REGION OF INTEREST FOR IMAGE CAPTURE

(71) Applicant: QUALCOMM INCORPORATED, San Diego, CA (US)

(72) Inventors: Jintao XU, Beijing (CN); Mian Ll, Shenzhen, Shang (CN); Hsuan Ming LIU, New Taipe City (TW); Yaoyao HOU, Beijing (CN)

(21) Appl. No.: 17/802,924

(22) PCT Filed: Feb. 27, 2020
(86) PCT No.: PCT/CN2020/077015

§ 371 Date: Aug. 26, 2022

(51) Int. Cl. H04N 23/611

(52) U.S. Cl. CPC H04N 23/611

(57) ABSTRACT

Methods, systems, and apparatuses are provided to determine a region of interest (404,504) to perform one or more camera operations, such as auto focus, automatic exposure, automatic gain, or automatic white balance. For example, an image capture device (100) obtains first image data from a sensor (115) of the device (100), and detects a region of interest (404,504) of the image data (165) that includes at least one face of a subject. The device (100) determines an orientation type of the face of the subject, and further determines whether the image data represents a high dynamic range scene. The device (100) adjusts the region of interest (404,504) in one or more directions based on the determined orientation type of the face and the determination of whether the scene is a high dynamic range scene. The device (100) may capture second image data based on the camera operations using the adjusted region of interest (404,504).

### BACKGROUND

### Field of the Disclosure

This disclosure relates generally to imaging devices and, more specifically, to adjusting a region of interest for image capture.

### Description of Related Art

Digital image capture devices, such as cameras in cell phones and smart devices, use various signal processing techniques in an attempt to render high quality images. For example, these image capture devices automatically focus their lens for image sharpness, automatically set the exposure time based on light levels, and automatically adjust the white balance to accommodate for the color temperature of a light source. In some examples, image capture devices include facial detection technology. Facial detection technology allows the image capture device to identify faces in a field of view of an image capture device's lens. The image capture device may then apply the various signal processing techniques based on the identified faces.

### SUMMARY

According to one aspect, a method for operating an image capture device comprises obtaining first image data. The first image data represents a subject within a field of view of the image capture device. The method includes detecting a region of interest of the first image data that includes a face of the subject. The method further includes determining an orientation type of the face of the subject based on the region of interest. The method also includes adjusting the region of interest based on the orientation type of the face of the subject. Further, the method includes performing at least one image capture operation based on the adjusted region of interest. The at least one image capture operation may include performing (e.g., adjusting) one or more of automatic focus, automatic gain, automatic exposure, or automatic white balance using the adjusted region of interest.

According to another aspect, an image capture device comprises a non-transitory, machine-readable storage medium storing instructions, and at least one processor coupled to the non-transitory, machine-readable storage medium. The at least one processor is configured to execute the instructions to obtain first image data. The first image data represents a subject within a field of view of the image capture device. The processor is also configured to execute the instructions to detect a region of interest of the first image data that includes a face of the subject. Further, the processor is configured to execute the instructions to determine an orientation type of the face of the subject based on the region of interest. The processor is also configured to execute the instructions to adjust the region of interest based on the orientation type of the face of the subject. The processor is further configured to execute the instructions to perform at least one image capture operation based on the adjusted region of interest.

According to another aspect, a non-transitory, machine-readable storage medium stores instructions that, when executed by at least one processor, causes the at least one processor to perform operations comprising obtaining first image data. The first image data represents a subject within a field of view of an image capture device. The storage medium stores further instructions that, when executed by the at least one processor, cause the at least one processor to: detect a region of interest of the first image data that includes a face of the subject; determine an orientation type of the face of the subject based on the region of interest; adjust the region of interest based on the orientation type of the face of the subject; and perform at least one image capture operation based on the adjusted region of interest.

According to another aspect, an image capture device comprises: a means for obtaining first image data, the first image data representing a subject within a field of view of an image capture device; a means for detecting a region of interest of the first image data that includes a face of the subject; a means for determining an orientation type of the face of the subject based on the region of interest; a means for adjusting the region of interest based on the orientation type of the face of the subject; and a means for performing at least one image capture operation based on the adjusted region of interest.

### BRIEF DESCRIPTION OF DRAWINGS

FIG. 1 is a block diagram of an exemplary image capture device, according to some implementations;

FIGS. 2 and 3 are diagrams illustrating components of an exemplary image capture device, according to some implementations;

FIGS. 4A, 4B, and 5A, 5B, and 5C illustrate images showing a subject in a field of view (FOV) of an exemplary image capture device, according to some implementations;

FIGS. 6 and 7 is a flowchart of an exemplary process for adjusting a region of interest within captured image data, according to some implementations; and

FIG. 8 is a flowchart of an exemplary process for performing an image capture operation in an image capture device, according to some implementations.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

Many image capture devices, such as cameras, are equipped to identify faces in the field of view (FOV) of the camera, and select a lens position that provides a focus value for a region of interest (ROI) containing the identified faces. The selected lens position, however, may not result in an optimal captured image for one or more of the faces within the ROI. For example, the ROI may include only a portion of the face, or may include areas of the FOV other than where the face appears, such as areas that include objects in the background of an image.

In some implementations, an image capture device may adjust the ROI for improved automatic focus (AF), automatic exposure (AE), automatic gain (AG), or automatic white balance (AWB) control, and corresponding methods. The image capture device may identify a subject within its FOV, and determine the ROI (e.g., the original ROI) that includes the face of the subject. The image capture device may further determine a pose angle of the face of the subject within the FOV, and determine an orientation type of the face of the subject based on the ROI and the pose angle. The orientation type of the face may include, for example, a front-facing orientation (e.g., looking along a line of sight of an image sensor of the image capture device), or a profile orientation (e.g., looking perpendicular to the line of sight of the image sensor of the image capture device).

The image capture device may then adjust the ROI based on the orientation type of the face of the subject. For example, the image capture device may extend the ROI in a vertical direction (e.g., along a centerline of the original ROI). As another example, the image capture device may reduce the ROI along a horizontal direction (e.g., perpendicular to the centerline of the original ROI).

In some examples, the image capture device may determine whether captured image data identifies a “high dynamic range” scene, or a “non-high dynamic range” scene (e.g., a “low dynamic range” scene), based on a comparison of the luminance of all of the captured image data and the luminance of a portion of the image data within the ROI. For instance, the image capture device may identify a “high dynamic range” scene when the luminance of the image data within the ROI differs by at least a threshold amount from the luminance of all of the image data. In some examples, the image capture device may identify a “non-high dynamic range” scene when the luminance of the image data within the ROI fails to differ by at least the threshold amount from the luminance of all of the image data. The image capture device may then adjust the ROI based on the orientation type of the face of the subject as well as whether the image data identifies a “high dynamic range” scene or a “non-high dynamic range” scene.

The image capture device may then determine (e.g., adjust, apply) one or more of AF, AE, AG, or AWB control based on image data within the adjusted ROI. In this description, unless expressly stated otherwise, the adjusted ROI refers to the region of interest that the image capture device uses during an operation, such as AF, AE, AG, and/or AWB.

In some examples, the image capture device may provide automated image capture enhancements based on a more accurate determination of a ROI that includes faces of subjects within captured image data. For example, the image capture device may automatically optimize one or more of AF, AE, AG, or AWB based on image data identified within its field of view that more accurately represents the face of subjects. Stated differently, the image capture device may adjust one or more of AF, AE, AG, or AWB based on a ROI that includes a larger portion of a subject's face compared to adjustment processes implemented via conventional cameras.

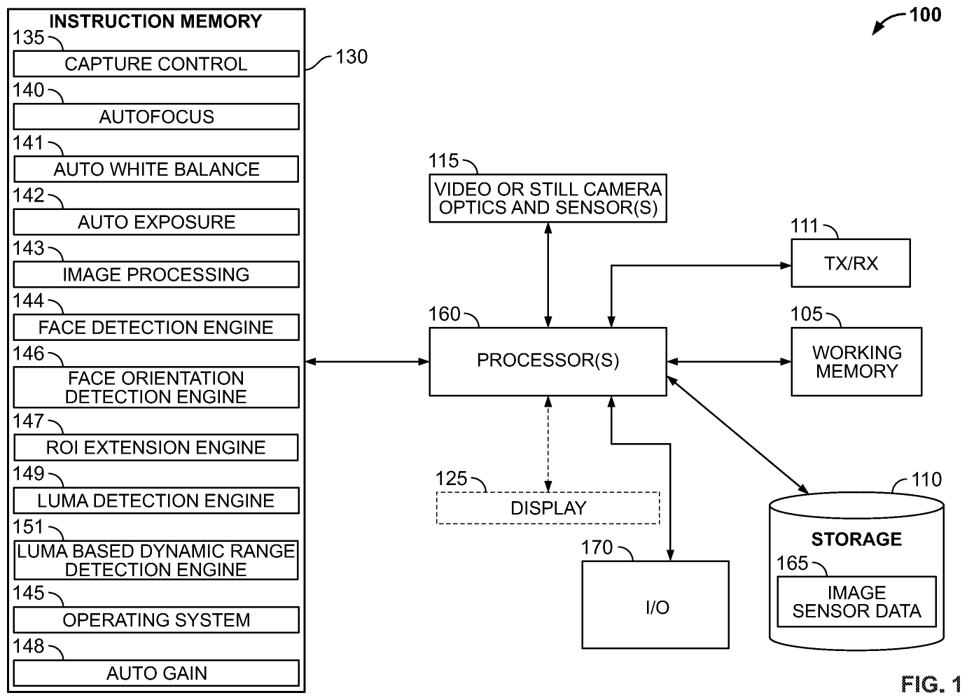

FIG. 1 is a block diagram of an exemplary image capture device 100. The functions of image capture device 100 may be implemented in one or more processors, one or more field-programmable gate arrays (FPGAs), one or more application-specific integrated circuits (ASICs), one or more state machines, digital circuitry, any other suitable circuitry, or any suitable hardware. In this example, image capture device 100 includes at least one processor 160 that is operatively coupled to (e.g., in communication with) camera optics and sensor 115 for capturing images. Camera optics and sensor 115 may include one or more image sensors and one or more lenses to capture images. Processor 160 is also operatively coupled to instruction memory 130, working memory 105, input device 170, transceiver 111, and storage medium 110. Input device 170 may be, for example, a keyboard, a touchpad, a stylus, a touchscreen, or any other suitable input device. In some examples, processor 160 is also operatively coupled to display 125.

The image capture device 100 may be implemented in a computer with image capture capability, a special-purpose camera, a multi-purpose device capable of performing imaging and non-imaging applications, or any other suitable device. For example, image capture device 100 may be a portable personal computing device such as a mobile phone, digital camera, tablet computer, laptop computer, personal digital assistant, or any other suitable device.

Although this description refers to processor 160, in some examples processor 160 may include one or more processors. For example, processor 160 may include one or more central processing units (CPUs), one or more graphics processing units (GPU), one or more digital signal processors (DSPs), one or more image signal processors (ISPs), one or more device processors, and/or one or more of any other suitable processors. Processor 160 may perform various image capture operations on received image data to execute AF, AG, AE, and/or AWB. Processor 160 may also perform various management tasks such as controlling optional display 125 to display captured images, or writing to or reading data from working memory 105 or storage medium 110. In some examples, processor 160 may also configure image capture parameters that are used to capture images, such as AF, AE, and/or AWB parameters.

In some instances, transceiver 111 facilitates communications between image capture device 100 and one or more network-connected computing systems or devices across a communications network using any suitable communications protocol. Examples of these communications protocols include, but are not limited to, cellular communication protocols such as code-division multiple access (CDM A®), Global System for Mobile Communication (GSM®), or Wideband Code Division Multiple Access (WCDMA®) and/or wireless local area network protocols such as IEEE 802.11 (WiFi®) or Worldwide Interoperability for Microwave Access (WiMAX®).

Processor 160 may control camera optics and sensor 115 to capture images. For example, processor 160 may instruct camera optics and sensor 115 to initiate an image capture (e.g., take a picture), and may receive the captured image data from camera optics and sensor 115. In some examples, camera optics and sensor 115, storage medium 110, and processor 160 provide a means for capturing first image data from a front-facing camera based on at least one of AF, AG, AE, or AWB using a first selected ROI. In some examples, camera optics and sensor 115, storage medium 110, and processor 160 provide a means for capturing second image data from a rear-facing camera based on at least one of AF, AG, AE, or AWB using a second selected ROI.

Instruction memory 130 may store instructions that may be accessed e.g., read) and executed by processor 160. For example, instruction memory 130 may include read-only memory (ROM) such as electrically erasable programmable read-only memory (EEPROM), flash memory, a removable disk, CD-ROM, any non-volatile memory, or any other suitable memory.

Processor 160 may store data to, and read data from, working memory 105. For example, processor 160 may store a working set of instructions to working memory 105, such as instructions loaded from instruction memory 130. Processor 160 may also use working memory 105 to store dynamic data created during the operation of image capture device 100. Working memory 105 may be a random access memory (RAM) such as a static random access memory (SRAM) or dynamic random access memory (DRAM), or any other suitable memory.

In this example, instruction memory 130 stores capture control instructions 135, AF instructions 140, AWB instructions 141, AE instructions 142, AG instructions 148, image processing instructions 143, face detection engine 144, face orientation detection engine 146, ROI extension engine 147, luma detection engine 149, luma based dynamic range detection engine 151, and operating system instructions 145. Instruction memory 130 may also include additional instructions that configure processor 160 to perform various image processing and device management tasks.

AF instructions 140 may include instructions that, when executed by processor 160, cause a lens of camera optics and sensor 115 to adjust a position of a corresponding lens. For example, processor 160 may cause the lens of camera optics and sensor 115 to adjust so that light from a ROI within a FOV of the imaging sensor is focused in a plane of the sensor. The selected ROI may correspond to one or more focus points of the AF system. AF instructions 140 may include instructions for executing autofocus functions, such as finding the optimal lens position for bringing light from a ROI into focus in the plane of a sensor. Autofocus may include, for example, phase detection autofocus (PDAF), contrast autofocus, or laser autofocus.

AWB instructions 141 may include instructions that, when executed by processor 160, cause processor 160 to determine a color correction to be applied to an image. For example, the executed AWB instructions 141 may cause processor 160 to determine an average color temperature of the illuminating light source under which camera optics and sensor 115 captured an image, and to scale color components (e.g., R, G, and B) of the captured image so they conform to the light in which the image is to be displayed or printed. Further, in some examples, executed AWB instructions 141 may cause processor 160 to determine the illuminating light source in a ROI of the image. The processor 160 may then apply a color correction to the image based on the determined color temperature of the illuminating light source in the ROI of the image.

AG instructions 148 may include instructions that, when executed by processor 160, cause processor 160 to determine a gain correction to be applied to an image. For example, the executed AG instructions 148 may cause processor 160 to amplify a signal received from a lens of camera optics and sensor 115. Executed AG instructions 148 may also cause processor 160 to adjust pixel values e.g., digital gain).

AF instructions 142 may include instructions that, when executed by processor 160, cause processor 160 to determine the length of time that one or more sensing elements, such as an imaging sensor of camera optics and sensor 115, integrate light before capturing an image. For example, executed AE instructions 142 may cause processor 160 to meter ambient light, and select an exposure time for a lens based on the metering of the ambient light. As the ambient light level increases, the selected exposure time becomes shorter, and as the ambient light level decreases, the selected exposure time becomes longer. In the case of a digital single-lens reflex (DSLR) camera, for example, executed AE instructions 142 may cause processor 160 to determine the exposure speed. In further examples, executed AE instructions 142 may cause processor 160 to meter the ambient light in a ROI of the field of view of a sensor of camera optics and sensor 115.

Capture control instructions 135 may include instructions that, when executed by processor 160, cause processor 160 to adjust a lens position, set an exposure time, set a sensor gain, and/or configure a white balance filter of the image capture device 100. Capture control instructions 135 may further include instructions that, when executed by processor 160, control the overall image capture functions of image capture device 100. For example, executed capture control instructions 135 may cause processor 160 to execute AF instructions 140, which causes processor 160 to calculate a lens or sensor movement to achieve a desired autofocus position and output a lens control signal to control a lens of camera optics and sensor 115.

Image processing instructions 143 may include instructions that, when executed, cause processor 160 to perform one or more image processing operations involving captured image data, such as, but not limited to, demosaicing, noise reduction, cross-talk reduction, color processing, gamma adjustment, image filtering (e.g., spatial image filtering), lens artifact or defect correction, image sharpening, or other image processing functions.

Operating system 145 may include instructions that, when executed by processor 160, cause processor 160 to implement an operating system. The operating system may act as an intermediary between programs, such as user applications, and the processor 160. Operating system instructions 145 may include device drivers to manage hardware resources such as the camera optics and sensor 115, display 125, or transceiver 111. Further, one or more of executed image processing instructions 143, as discussed above, may interact with hardware resources indirectly through standard subroutines or application programming interfaces (APIs) that may be included in operating system instructions 145. The executed instructions of operating system 145 may then interact directly with these hardware components.

Face detection engine 144 may include instructions that, when executed by processor 160, cause processor 160 to initiate facial detection on image data representing one or more subjects within a field of view of image capture device 100. For example, processor 160 may execute face detection engine 144 to determine a ROI within a field of view of a lens of camera optics and sensor 115 that includes one or more faces of corresponding subjects. In some instances, face detection engine 144 may, upon execution by processor 160, obtain raw image sensor data of an image in a field of view of a lens of camera optics and sensor 115. Executed face detection engine 144 may also may initiate face detection, and may determine if one or more faces of subjects are in the field of view by, for example, performing facial detection operations locally within processor 160. The facial detection operations may include, but are not limited to, performing computations to determine if the field of view of image capture device 100 contains one or more faces and, if so, to determine (e.g., and identify) a region in the FOV (e.g., a ROI) containing the one or more faces.

In other embodiments, processor 160 may initiate remote performance of face detection by transmitting a request to a cloud processor or other remote server. In some examples, the request includes the raw image sensor data of the image in the field of view of the lens of camera optics and sensor 115. In some examples, processor 160 stores the image sensor data 165 received from one or more lenses of camera optics and sensor 115 in a non-transitory, machine-readable storage medium 110, such as a hard drive, a solid-state memory, or a FLASH memory, for example and additionally, or alternatively, in cloud storage. The request may include an identifier of a location of where the image sensor data 165 is stored, and the request may cause the cloud processor or other remote server to perform computations to determine if the field of view of image capture device 100 contains one or more faces and to respond to processor 160 with an identification of the region in the FOV containing the one or more faces.

Further, and as described further below, face detection engine 144 may also include instructions that, when executed by processor 160, cause processor 160 to determine a pose angle of the subject. In some examples, face detection engine 144 include further instructions that, when executed by processor 160, cause processor 160 to determine a location of facial features, such as an eye or a mouth.

Face orientation detection engine 146 may include instructions that, when executed by processor 160, cause processor 160 to determine an orientation type of the detected face(s) (e.g., as detected by processor 160 executing face detection engine 144). For example, processor 160 may execute face orientation detection engine 146 to determine whether a detected face is disposed in a front-facing orientation (e.g., the subject's face is directed in the direction of a lens of camera optics and sensor 115), or alternatively, is disposed in a profile orientation (e.g., the subject's face is directed nearly perpendicular to the lens of camera optics and sensor 115). Further, in some examples, face orientation detection engine 146 may also include instructions that, when executed by processor 160, cause processor 160 to determine the orientation type of detected faces using one or more orientation-determining processes. For instance, and based on received a power configuration signal (e.g., a configuration setting), executed face orientation detection engine 146 may select an orientation-determining process (e.g., one or more corresponding algorithms) that, when applied to captured image data, determine the orientation type of the detected faces.

ROI extension engine 147 may include instructions that, when executed by processor 160, cause processor 160 to adjust a ROI within captured image data (e.g., as determined by processor 160 executing face detection engine 144). In some examples, ROI extension engine 147 may, upon execution by processor 160, cause processor 160 to adjust the ROI in a first direction, such as a vertical direction (e.g., along a “y” axis, such as along an axis parallel to a centerline of the ROI). For example, executed ROI extension engine 147 may cause processor 160 to expand increases), or reduce (e.g., decreases), the ROI in the vertical direction. ROI extension engine 147 may also include instructions that, when executed by processor 160, cause processor 160 to adjust the ROI in a second direction, such as a horizontal direction (e.g., along an “x” axis, such as along an axis that runs perpendicular to a centerline of the ROI). For example, processor 160 may expand, or reduce, the ROI in the horizontal direction.

ROI extension engine 147 may also include instructions that, when executed by processor 160, cause processor 160 to adjust the ROI based on the determined orientation type of a detected face (e.g., as determined by processor 160 executing face orientation detection engine 146). The adjusted ROI may be used for performing AF, AE, AG, and/or AWB.

For example, processor 160 may extend the ROI in a first direction (e.g., the vertical direction) by a first amount when the detected face is disposed in a front-facing orientation, and extend the ROI in the first direction by a second amount when the detected face is disposed in a profile orientation. In some instances, the first amount may exceed the second amount. By way of example, the first amount may include a number of pixels or a non-zero percentage of a corresponding dimension in the first direction, and the second amount may be zero pixels or a zero percentage (e.g., no adjustment in the first direction).

Luma detection engine 149 may include instructions that, when executed by processor 160, cause processor 160 to determine values, such as luminance values, based on pixel values of pixels of the captured image data and pixel values of pixels within the detected ROI (e.g., the ROI detected by processor 160 executing face detection engine 144). For example, luma detection engine 149, upon execution by processor 160, may determine a first value based on luminance pixel values of all pixels of a captured image, such as image data within a field of view of a lens of camera optics and sensor 115. Executed luma detection engine 149 may also cause processor 160 to determine a second value based on luminance pixel values of all pixels within the detected ROI that includes a face of a subject. In some examples, one or more of the first value and the second value include average luminance pixel values of the corresponding pixel values. In other examples, one or more of the first value and the second value include median luminance pixel values of the corresponding pixel values. In yet other examples, the first value and the second value may be determined based on any suitable mathematical or statistical process or technique, such as, but not limited to, determining a total sum of squares.

Luma, based dynamic range detection engine 151 may include instructions that, when executed by processor 160, cause processor 160 to determine whether captured image data (e.g., image sensor data) identifies a “high dynamic range” scene or “non-high dynamic range” scene based on the values determined by executed luma detection engine 149 (e.g., the first value and the second value). For example, and upon execution by processor 160, executed luma based dynamic range detection engine 151 may compare the first value to the second value, and determine whether the captured image data identifies a “high dynamic range” scene or a “non-high dynamic range” scene based on the comparison. In some instances, executed luma based dynamic range detection engine 151 may determine a difference between the first value and the second value, and if the difference were greater than a threshold amount (e.g., a predetermined threshold amount), executed luma based dynamic range detection engine 151 may determine that the captured image data identifies a “high dynamic range” scene. Alternatively, if the difference were equivalent to, or less than, the threshold amount, executed luma based dynamic range detection engine 151 may determine that the captured image data identifies a “non-high dynamic range” scene. In other instances, executed luma based dynamic range detection engine 151 may determine whether the captured image data identifies a “high dynamic range” scene or a “non-high dynamic range” scene based on applying any suitable mathematical or statistical process or technique to the first value and the second value.

In some examples, ROI extension engine 147 may include instructions that, when executed by processor 160, cause processor 160 to adjust the ROI based on the determined orientation type of a detected face (e.g., as described herein) and further, based on the determination of whether image sensor data 165 identifies a “high dynamic range” scene or a “non-high dynamic range” scene (e.g., as determined by luma based dynamic range detection engine 151). For example, ROI extension engine 147 may, upon execution by processor 160, cause processor 160 to extend the ROI vertically by a first amount (e.g., a number of pixels, a percentage of a current vertical pixel size, etc.) when the detected face is disposed in a front-facing orientation and when the scene identifies a “high dynamic range” scene. Executed ROI extension engine 147 may also cause processor 160 to extend the ROI vertically by a second amount when the detected face is disposed in the front-facing orientation and when the scene identifies a “non-high dynamic range” scene. In some examples, the second amount may exceed the first amount (e.g., the second amount may represent an integer multiplier of the first amount, such as double the first amount).

In some examples, executed ROI extension engine 147 may cause processor 160 to reduce the ROI in a second direction (e.g., horizontally) by a first amount when the face is in a front-facing orientation, and reduce the ROI in the second direction by a second amount when the face is in a profile orientation. In some examples, the first amount is less than the second amount.

Further, executed ROI extension engine 147 may also cause processor 160 to reduce the ROI in a second direction (e.g., the horizontal direction described herein) by a first amount when the scene corresponds to a “high dynamic range” scene. Additionally, executed ROI extension engine 147 may cause processor 160 to reduce the ROI in the second direction by a second amount when the scene identifies a “non-high dynamic range” scene. In some examples, the second amount may exceed the first amount (e.g., the first amount may be 50%, and the second amount may be 60% or 70%).

As described herein, processor 160 may perform one or more of AF, AE, AG, and/or AWB based on the adjusted ROI of captured image data 165. For example, executed ROI extension engine 147 may cause processor 160 to use the adjusted ROI as the ROI when executing AF instructions 140. Similarly, executed ROI extension engine 147 may cause processor 160 to use the adjusted ROI as the ROI when executing AWB instructions 141, AG instructions 148, or AE instructions 142.

In some implementations, described herein, each of face detection engine 144, face orientation detection engine 146, ROI extension engine 147, luma detection engine 149, and luma based dynamic range detection engine 151 may be implemented through executable instructions that are stored in a non-volatile memory (e.g., instruction memory 130) and are executed by one or more processors of image capture device 100 (e.g., processor 160). In other implementations examples, one or more of face detection engine 144, face orientation detection engine 146, ROI extension engine 147, luma detection engine 149, and luma based dynamic range detection engine 151 may be implemented in hardware (e.g., in an FPGA, ASIC, using discrete logic, etc.).

Although in FIG. 1, processor 160 is located within image capture device 100, in some examples, processor 160 may include one or more cloud-distributed processors. For example, one or more of the functions described herein with respect to processor 160 may be carried out (e.g., performed) by one or more remote processors, such as one or more cloud processors within corresponding cloud-based servers. The cloud processors may communicate with processor 160 via a network, where processor 160 connects to the network via transceiver 111. Each of the cloud processors may be coupled to non-transitory cloud storage media, which may be collocated with, or remote from, the corresponding cloud processor. The nets may be any personal area network (PAN), local area network (LAN), wide area network (WAN) or the Internet.

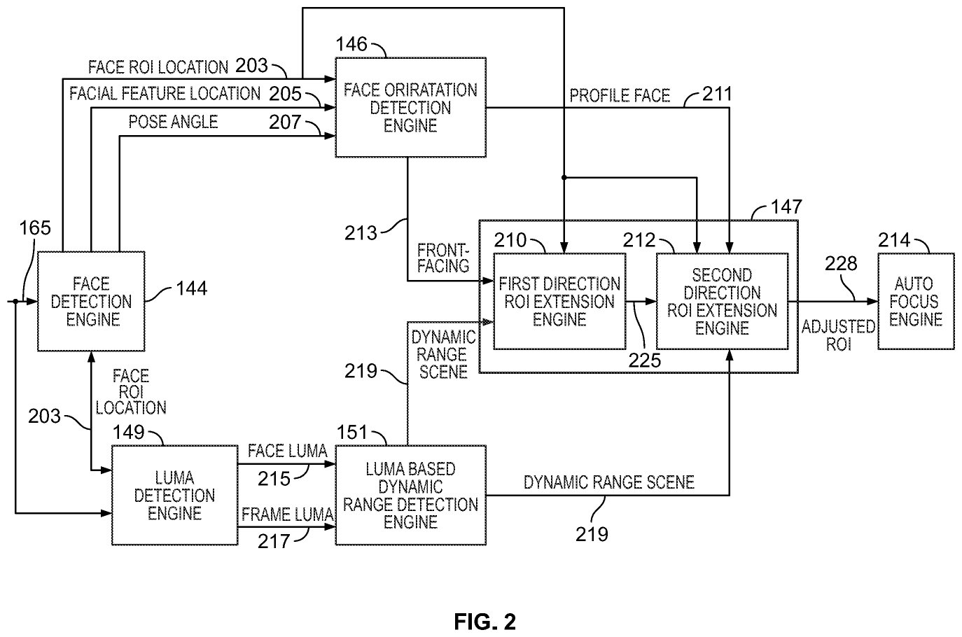

FIG. 2 is a diagram illustrating exemplary components of the image capture device 100 of FIG. 1. As illustrated, image capture device 100 may include face detection engine 144, face orientation detection engine 146, luma detection engine 149, luma based dynamic range detection engine 151, ROI extension engine 147 (which in this example comprises first direction ROI adjustment engine 210 and second direction ROI adjustment engine 212), and autofocus engine 214. In some examples, each of these exemplary components may be implemented through executable instructions that are stored in a non-volatile memory (e.g., instruction memory 130 of FIG. 1) and are executed by one or more processors of image capture device 100 (e.g., processor 160 of FIG. 1). In other examples, one or more of these exemplary components may be implemented in hardware (e.g., in an FPGA, ASIC, using discrete logic, etc.).

As illustrated in FIG. 2, face detection 144 may receive image sensor data 165 from camera optics and sensor 115, and may determine a ROI that includes a face of a subject. Face detection engine 144 may employ any known techniques or processes for determining a ROI in image data that includes a face of a subject. For example, upon receipt of image sensor data 165, face detection engine 144 may initiate face detection operations, and may determine if image sensor data 165 includes the face of the subject. When image sensor data 165 includes the face of the subject, face detection engine 144 may perform additional face detection operations that generate face ROI location data 203, which identifies and characterizes a ROI within image sensor data 165 that includes the face of the subject.

In some embodiments, face detection engine 144 may further process image sensor data 165 and ROA location data 203 to determine a location, within the determined ROI, of one or more facial features. For example, face detection engine 144 may perform operations to detect an eye and/or a mouth of the face of the subject within the ROI. Based on the performance of these operations, face detection engine 144 may generate facial feature location data 205 that identifies and characterizes the location of the detected facial features.

Further, face detection engine 144 may also determine a pose angle of the face of the subject. For example, face detection engine 144 may perform operations that determine the e angle based on the location of determined facial features, e.g., as specified within facial feature location data 205. In some examples, face detection engine 144 identifies an eye location and a mouth location within the ROI that includes the face of the subject, and may determine the pose angle based on one or more of the identified eye location and mouth location. Face detection engine 144 may generate pose angle data 207 identifying and characterizing the determined pose angle of the face of the subject.

As illustrated in FIG. 2, face orientation detection engine 146 may receive face ROI location data 203, facial feature location data 205, and pose angle data 207 from face detection engine 144. In some examples, face orientation detection engine 146 may determine an orientation type of the face within the ROI identified by face ROI location data 203 based on the pose angle identified by pose angle data 207. For instance, face orientation detection engine 146 may compare the pose angle to a threshold angle. The threshold angle may be a preconfigured angle (e.g., stored in storage medium 110), and may be configured by a user (e.g., a configuration setting). If the pose angle identified by pose angle data 207 fails to exceed the threshold angle (e.g., ten degrees), face orientation detection engine 146 may determine that the face is disposed in a front-facing orientation (e.g., front-facing). Otherwise, if the pose angle is equivalent to or exceeds the threshold angle, face orientation detection engine 146 may determine that the face is disposed in a profile orientation.

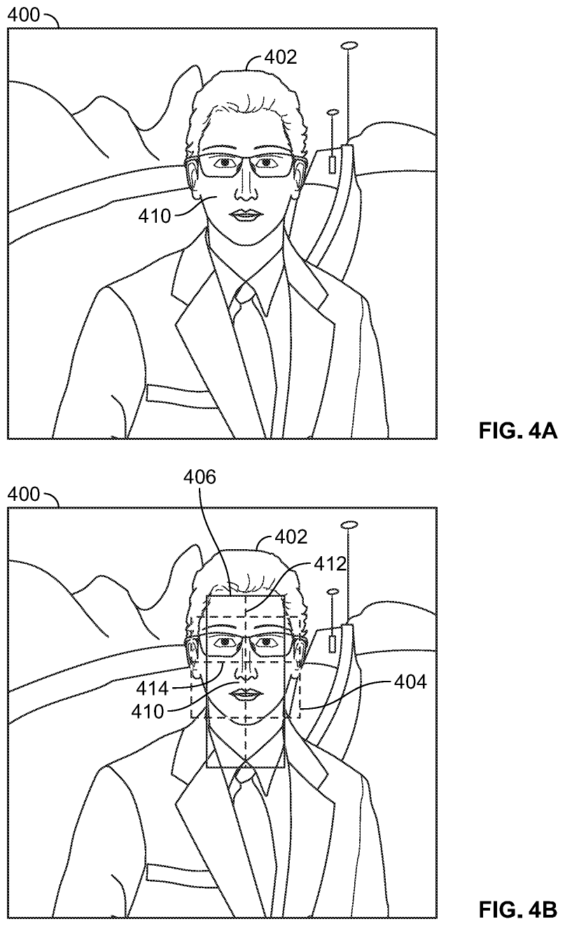

In further examples, face orientation detection engine 146 may also determine the orientation of the face based on one or more facial features identified by facial feature location data 205. For instance, face orientation detection engine 146 may receive facial feature location data 205, and may determine a distance between the one or more facial features (e.g., from a center point of each facial feature) to a center location of the ROI identified by face ROI location data 203. As an example, and with reference to FIG. 4B below, the intersection of vertical line 212 and horizontal line 214 identifies the center location of ROI 204.

In some examples, face orientation detection engine 146 may compute the center location of the ROI. For example, face orientation detection engine 146 may determine a horizontal location (e.g., along the “x” axis) of a pixel located halfway between a position of a left-most pixel and a position of a right-most pixel of the ROI (e.g., x₁+(x₂−x₁)/2). Similarly, face orientation detection engine 146 may determine a vertical location (e.g., along the “x” axis) of a pixel located halfway between a position of an uppermost pixel and a position of a lower-most pixel of the ROI (e.g., y₁+(y₂−y₁)/2).

For instance, facial feature location data 205 may identify a location of an eye, a nose, and a mouth, face orientation detection engine 146 may determine a determine a distance between the center location of ROI 204 to each of the eye, nose, and mouth identified by facial feature location data 205. Based on these computed distances, face orientation detection engine 146 determines the orientation type of the face, e.g., the front-facing orientation or the profile orientation described herein. For example, face orientation detection engine 146 may compare each determined distance to a threshold distance. The threshold distance may include a predetermined number of pixels, which may be stored in storage medium 110, and may be configurable by a user (e.g., a configuration setting). Face orientation detection engine 146 may determine whether each detected distance exceeds, or falls within, the threshold distance, and determine the orientation type of the face based on the determination.

As an example, face orientation detection engine 146 may determine whether a distance between an eye of the face and the center point of the ROI exceeds the threshold distance. If the distance exceeds the threshold distance, face orientation detection engine 146 may determine that the face is in a front-facing orientation. Otherwise, if the distance falls below the threshold, face orientation detection engine 146 may determine that the face is in a profile orientation.

In another example, face orientation detection engine 146 may determine whether a distance between a mouth of the face and the center point of the ROI exceeds the threshold distance. If the distance exceeds the threshold distance, face orientation detection engine 146 may determine that the face is in a front-facing orientation. Otherwise, if the distance falls below the threshold, face orientation detection engine 146 may determine that the face is in a profile orientation.

Additionally, in some examples, face orientation detection engine 146 may assign a weight to each identified facial feature (e.g., as identified by facial feature location data 205). Face orientation detection engine 146 may determine the orientation type of the face based on the weighted identified facial features. For example, face orientation detection engine 146 may assign a first weight (e.g., 0.4) to a first eye of a face, a second weight (0.2) to a second eye of the face, a third weight to a mouth of the face (e.g., 0.3), and a fourth weight to a nose of the face (e.g., 0.1). For each individual feature, face orientation detection engine 146 determines an orientation type of the face (e.g., based on corresponding threshold distances), and applies the corresponding weight to each initial determination to make a final. determination of the orientation type of the face.

For example, face orientation detection engine 146 may determine a front-facing orientation based on the facial feature of the first eye, but may determine a profile orientation based on the facial features of the second eye, mouth, and nose. As such, and using the example weights above, face orientation detection engine 146 may compute a score of 0.4 for the front-facing orientation, and a score of 0.6 for the profile orientation. Face orientation detection engine 146 may compare the front-facing orientation and profile orientation values to make a final determination of the orientation type of the face. In this example, face orientation detection engine 146 may determine that 0.6 is greater than 0.4, and determine that the orientation type of the face is the profile orientation. In some examples, face orientation detection engine 146 may also assign a weight to the determination of the orientation type of the face based on the pose angle, and makes the final determination of the orientation type of the face based on the weighted determinations.

In some examples, rather than threshold distances, face orientation detection engine 146 may compare the determined distances to facial feature ranges, where each facial feature range identifies a range of possible pixel distances from a corresponding facial feature to the center point of the ROI. The facial feature ranges may identify a range of values for one or more orientations of the face (e.g., facial feature ranges for front-facing, and facial feature ranges for profile face).

Face orientation detection engine 146 may compare the determined distances, as described herein, to data, e.g., “face profile” data, stored in storage medium 110. The face profile data may identify relative distances between facial features for one or more potential orientation types of a face, and face orientation detection engine 146 may establish one of the potential orientation types as the orientation type of the face based on a closest matching face profile. As an example, the closest matching face profile may be determined according to the lowest average relative distance of the identified relative distances. Further, in some instances, face orientation detection engine 146 may apply a weight (e.g., a predetermined weight) to each relative distance, and may determine the closest matching face profile based on the weighted relative distances (e.g., lowest average relative distance of the weighted relative distances). In other examples, face orientation detection engine 146 employ any additional, or alternate, technique or process to determine the closest matching face profile.

As illustrated in FIG. 2, luma detection engine 149 may receive image sensor data 165, and may also receive face ROI location data 203 as an input from face detection engine 144. Luma detection engine 149 may process image sensor data 165 and ROI location data 203, and may determine (e.g., compute) a first luminance value based on luminance pixel values for each pixel within the ROI identified by face ROI location data 203. For example, luma detection engine 149 may determine an average luminance value for the luminance pixel values of the pixels within the ROI, and may generate face luma data 215 that includes the first luminance value.

Similarly, luma detection engine 149 determines a second luminance value based on luminance pixel values for all pixels identified by image sensor data 165 (e.g., all pixels within the image frame captured by the camera optics and sensor 115). For example, luma detection engine 149 may determine an average luminance value for the luminance pixel values of the pixels identified by image sensor data 165, and luma detection engine 149 may generate frame luma data 217 that includes the second luminance value.

Luma based dynamic range detection engine 151 may receive face luma data 215 and frame luma data 217 from luma detection engine 149, and may generate dynamic range scene data 219 based on the first luminance value and the second luminance value. For instance, dynamic range scene data 219 may specify whether the image sensor data 165 identifies a “high dynamic range” scene or a “non-high dynamic range” scene.

As an example, luma based dynamic range detection engine 151 may determine a ratio of the first luminance value identified by face luma data 215 and the second luminance value frame luma data 217. Luma based dynamic range detection engine 151 may further determine whether the ratio exceeds a ratio threshold (e.g., 120%), and based on the determination, may establish whether the scene represents a “high dynamic range” scene or a “non-high dynamic range” scene. The ratio threshold may be stored in storage medium 110, for example, and may be configurable by a user (e.g., a configuration setting). In some examples, if the determined ratio (as determined by computing the ratio of the first luminance value to the second luminance value) exceeds 120%, luma based dynamic range detection engine 151 may determine that the scene represents a “high dynamic range” scene. Alternatively, if the ratio is equivalent to or below 120%, luma based dynamic range detection engine 151 may determine that the scene represents a “non-high dynamic range” scene. The 120% ratio threshold is for exemplary purposes only, and in other examples, the comparison may involve any additional or alternate ratio threshold appropriate to captured image data 165.

As another example, luma based dynamic range detection engine 151 may determine whether the scene is a “high dynamic range” scene or a “non-high dynamic range” scene based on a difference between the first luminance value identified by face luma data 215 and the second luminance value frame luma data 217. For instance, luma based dynamic range detection engine 151 may compare the difference to a luma difference threshold, which may be stored in storage medium 110 and may be configurable by a user. If the difference exceeds the luma difference threshold, luma based dynamic range detection engine 151 may determine that the scene represents a “high dynamic range” scene. Otherwise, if the difference does not exceed the luma difference threshold, luma based dynamic range detection engine 151 may determine that the scene represents a “non-high dynamic range” scene.

In some instances, first direction ROI adjustment engine 210 and second direction ROI adjustment engine 212 may perform operations that, individually or collectively, adjust the ROI identified by face ROI location data 203 based on factors that include, but are not limited to, the determined orientation of the face (e.g., as determined by face direction orientation engine 146) and the determined dynamic range of the scene (e.g., as determined by luma based dynamic range detection engine 151). By way of example, first direction ROI adjustment engine 210 and second direction ROI adjustment engine 212 may adjust the ROI in different directions. For instance, first direction ROI adjustment engine 210 may be operable to adjust the ROI in a vertical direction (e.g., along a “y” axis), and second direction ROI adjustment engine 212 may be operable to adjust the ROI in a horizontal direction (e.g., along an “x” axis).

By way of example, first direction ROI adjustment engine 210 may adjust the ROI in a first direction (e.g., the vertical direction) based on one or more of front face data 213 and dynamic range scene data 219. For instance, first direction ROI adjustment engine 210 may extend the ROI in the first direction by a first amount (e.g., a number of pixels, a percentage of a current vertical pixel size, etc.) when the detected face is in a front-facing orientation (e.g., as identified by front face data 213), and the scene represents a “high dynamic range” scene (e.g., as identified by dynamic range scene data 219). Alternatively, first direction ROI adjustment engine 210 may extend the ROI in the first direction by a second amount when the detected face is in the front-facing orientation, but the scene represents a “non-high dynamic range” scene. In some examples, the second amount is greater than the first amount. First. direction ROI adjustment engine 210 may generate first direction adjusted ROI data 225 that identities and characterizes the adjustment to the ROI, and may provide first direction adjusted ROI data 225 to second direction ROI adjustment engine 212.

Second direction ROI adjustment engine 212 may adjust the ROI in a second direction (e.g., horizontally) based on one or more of profile face data 211 and dynamic range. scene data 219. For example, second direction ROI adjustment engine 212 may reduce the ROI in the second direction by a first amount when the scene represents a “high dynamic range” scene or alternatively, may reduce the ROI horizontally by a second amount when the scene represents a “non-high dynamic range” scene. In some instances, the second amount is greater than the first amount.

Additionally, second direction ROI adjustment engine 212 may determine a final adjusted ROI based on first direction adjusted ROI data 225 and any adjustments made by second direction ROI adjustment engine 212 (e.g., in the second direction). For example, in addition to making any adjustments to the ROI identified by face ROI location data 203 in the second direction, second direction ROI adjustment engine 212 may apply any adjustments identified by first direction adjusted ROI data 225 in the first direction to determine the final adjusted ROI.

Second direction ROI adjustment engine 212 may generate adjusted ROI data 228 identifying and characterizing the final adjusted ROI, and may output adjusted ROI data 228 to have any of the exemplary AF, AE, AG, and/or AWB described herein performed based on adjusted ROI data 228. For example, second direction ROI adjustment engine 212 may provide adjusted ROI data 228 to an autofocus engine 214 of image capture device 100. Autofocus engine 214 may perform one or more auto focus operations based on the adjusted ROI identified by adjusted ROI data 228. Further, and based on an output generated by autofocus engine 214, image capture device 100 may perform operations that cause a lens of camera optics and sensor 115 to adjust its lens position in accordance with the adjusted ROI.

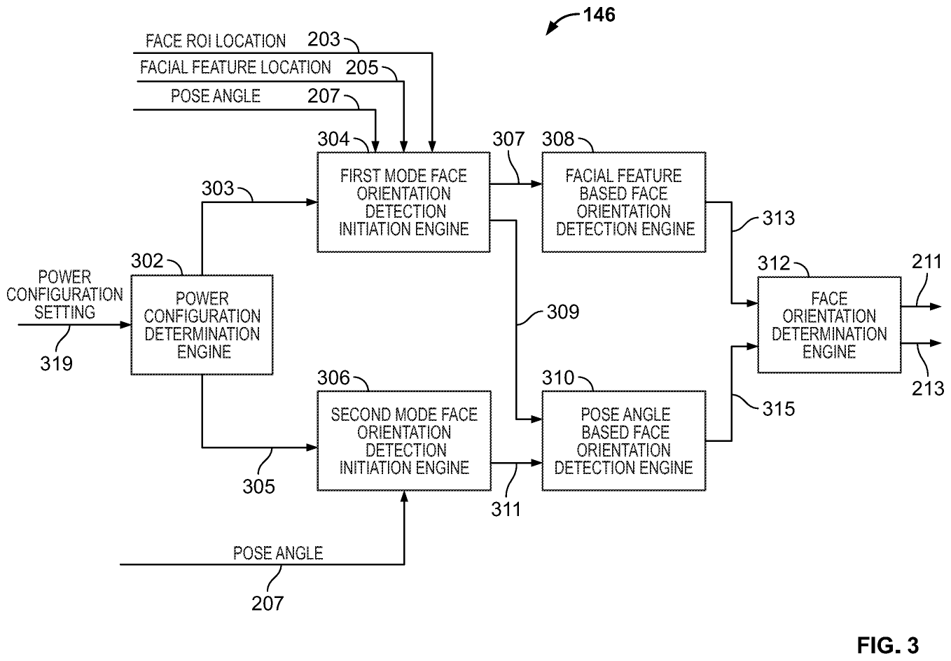

FIG. 3 is a diagram of face orientation detection engine 146, in accordance with some implementations. In this example, face orientation detection engine 146 includes power configuration determination engine 302, first mode face orientation detection initiation engine 304, second mode face orientation detection initiation engine 306, facial feature based face orientation detection engine 308, pose angle based face orientation detection engine 310, and face orientation determination engine 312. In some examples, one or more of power configuration determination engine 302, first mode face orientation detection initiation engine 304, second mode face orientation detection initiation engine 306, facial feature based face orientation detection engine 308, pose angle based face orientation detection engine 310, and face orientation determination engine 312 may be implemented in executable instructions stored in a non-volatile memory (e.g., instruction memory 130 of FIG. 1) that are executed by one or more processors (e.g., processor 160 of FIG. 1). In other examples, one or more of power configuration determination engine 302, first mode face orientation detection initiation engine 304, second mode face orientation detection initiation engine 306, facial feature based face orientation detection engine 308, pose angle based face orientation detection engine 310, and face orientation determination engine 312 may be implemented in hardware (e.g., in an FPGA, ASIC, using discrete logic, etc.).

As illustrated in FIG. 3, power configuration determination engine 302 may obtain power configuration setting 319 identifying a power configuration setting of image capture device 100, and enables at least one of a first mode or second mode of operation for detecting the orientation type of a face in the ROI identifying by face ROI location 203. In some examples, power configuration determination engine 302 may provide a first enable signal 303 to first mode face orientation detection initiation engine 304, and a second enable signal 305 to second mode face orientation detection initiation engine 306. Each of first enable signal 303 and second enable signal 305 may facilitate face orientation type detection operations consistent with the respective modes and using any of the exemplary processes described herein (e.g., as provided by first mode face orientation detection initiation engine 304 and second mode face orientation detection initiation engine 306). Power configuration setting 319 may identify a power configuration stored in storage medium 110, which may be configurable by a user.

Assuming first mode face orientation detection initiation engine 304 is enabled (e.g., via first enable signal 303), first mode face orientation detection initiation engine 304 may provide face ROI location data 203 and/or facial feature location data 205 to facial feature based face orientation detection engine 308 via first signal path 307. Facial feature based face orientation detection engine 308 may detect an orientation type of a face within the ROI identified by face ROI location data 203 based on face ROI location data 203 and/or facial feature location data 205, as described herein. Facial feature based face orientation detection engine 308 may also generate first face orientation data 313 identifying the determined orientation of the face, and provides first face orientation data 313 to face orientation determination engine 312.

In some embodiments, first mode face orientation detection initiation engine 304 may also provide pose angle data 207 to pose angle based face orientation detection engine 310 via second signal path 309. Pose angle based face orientation detection engine 310 may detect an orientation of a face within the ROI identified by face ROI location data 203 based on the pose angle identified by pose angle data 207 as described herein (e.g., with respect to FIG. 2 above). Pose angle based face orientation detection engine 310 may also generate second face orientation data 315 identifying the determined orientation type of the face, and provides second face orientation data 315 to face orientation determination engine 312.

Face orientation determination engine 312 may determine a final orientation of the face based on one or more of first face orientation data 313 and second face orientation data 315. For example, if the first mode were enabled (e.g., power configuration determination engine 302 enabled first mode face orientation detection initiation engine 304 via first enable signal 303), each of first face orientation data 313 and second face orientation data 315 may perform operations that identify an orientation type for the face. In some examples, if both orientations are the same (e.g., first face orientation data 313 and second face orientation data 315 indicate the same face orientation), face orientation determination engine 312 provides profile face data 211 and front face data 213 accordingly.

Additionally, and by way of example, if both first face orientation data 313 and second face orientation data 315 were to indicate a front-facing orientation, face orientation determination engine 312 may generate profile face data 211 indicating an absence of any profile orientation (e.g., profile face data 211 is 0; set “low” if active high). Face orientation determination engine 312 may further generate front face data 213 indicating a front-facing orientation (e.g., front face data 213 is 1; set “high” if active high). If, however, both first face orientation data 313 and second face orientation data 315 were to indicate a profile orientation, face orientation determination engine 312 provides profile face data 211 indicating the profile orientation (e.g., profile face data 211 is 1; set “high” if active high), and provides front face data 213 indicating an absence of any front-facing orientation (e.g., front face data 213 is 0; set “low” if active high).

Further, if first face orientation data 313 and second face orientation data 315 were to identify different orientation types for the face, face orientation determination engine 312 may apply weights to orientation decisions made by facial feature based face orientation detection engine 308 for each facial feature, as described herein (e.g., with respect to FIG. 2 above). Face orientation determination engine 312 may also apply weights to orientation type decisions made by pose angle based face orientation detection engine 310, and determine a final orientation for the face based on the weighted decisions, as described herein.

In other examples, if the second mode were enabled (e.g., power configuration determination engine 302 enabled second mode face orientation detection initiation engine 306 via second enable signal 305), second face orientation data 315 may identify the orientation type for the face. Face orientation determination engine 312 provides profile face data 211 and front face data 213 according to the identified orientation.

FIGS. 4A and 4B illustrate portions of an exemplary image 400 within a field of view of an exemplary image capture device, such as image capture device 100 of FIG. 1. The field of view may contain a single subject, or two or more subjects. In this example, the image preview 400 includes a face 410 of a first person 402, and face 410 is disposed in a front-facing orientation. Image capture device 100 may perform one or more of the facial detection processes described herein on image data associated with image 400 to detect face 410 of first person 402. For example, face detection engine 144, when executed by processor 160, may perform one or more operations on image data to determine region of interest 404, as illustrated in FIG. 4B.

In some examples, image capture device 100 may adjust region of interest 404 using any of the exemplary processes described herein. For example, ROI extension engine 147, when executed by processor 160, may adjust region of interest 404 based on the orientation type of face 410 to generate adjusted region of interest 406. Image capture device 100 may use the adjusted region of interest 406 to perform one or more of AF, AE, AG, and/or AWB.

In the example of FIG. 4B, image capture device 100 may generate adjusted region of interest 406 by expanding region of interest 404 along vertical line 412, e.g., on one or both sides of horizontal line 414, using any of the exemplary processes described herein. Vertical line 412 may be parallel to a “y” axis, while horizontal line 414 may be parallel to an “x” axis. In some examples, image capture device 100 expands region of interest 404 along vertical line 412 on either side of horizontal line 414 by an equal amount (e.g., by the same number of pixels, by the same percentage, etc.).

In some instances, vertical line 412 may represents a halfway point between the left side of the region of interest 404 and the right side of the region of interest 404, and horizontal line 414 may represent the halfway point between the top side of the region of interest 404 and the bottom side of the region of interest 404. Image capture device 100 may determine the locations of vertical line 412 and horizontal line 414 based on, for example, region of interest 404.

Image capture device 100 may further adjust region of interest 404 to generate adjusted region of interest 406 by reducing region of interest 404 along horizontal line 414 on either side of vertical line 412. In some examples, image capture device 100 reduces region of interest 404 along vertical line 412 on either side of horizontal line 414 by an equal amount.

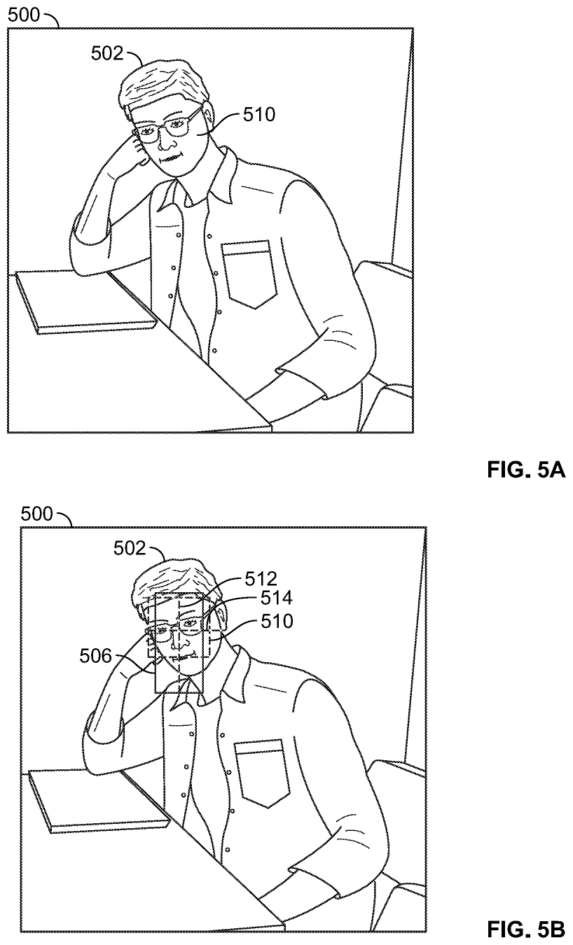

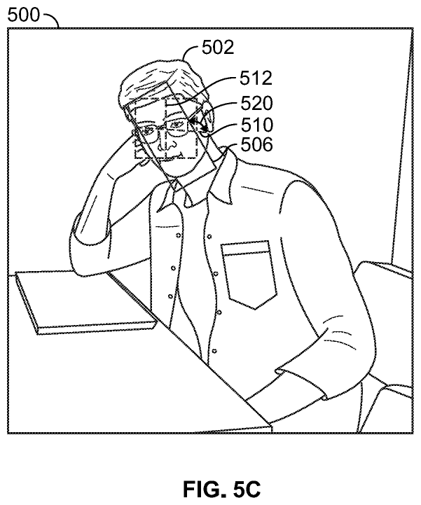

FIGS. 5A, 5B, and 5C illustrate an exemplary image preview 500 within a field of view of an exemplary image capture device, such as image capture device 100 of FIG. 1. In this example, the image preview 500 includes a face 510 a first person 502, and face 510 is disposed in a front-facing orientation. Image capture device 100 may perform any of the facial detection processes described herein on image data associated with image 500 to detect face 510 of first person 502. For example, FIG. 5B illustrates a region of interest 504 determined by image capture device 100 executing face detection engine 144.

In some examples, image capture device 100 may adjust the region of interest 504 using any of the exemplary processes described herein. For example, ROI extension engine 147 adjust region of interest 504 based on the orientation type of face 510 to generate adjusted region of interest 506. Image capture device 100 may use the adjusted region of interest 506 to perform one or more of AF, AE, AG, and/or AWB.

In this example, image capture device 100 generates adjusted region of interest 506 by expanding region of interest 504 along vertical line 512, e.g., on one or both sides of horizontal line 514, using any of the exemplary processes described herein. In some examples, image capture device 100 expands region of interest 504 along vertical line 512 on either side of horizontal line 514 by an equal amount (e.g., by the same number of pixels, by the same percentage, etc.).

Vertical line 512 may represent a halfway point between the left side of the region of interest 504 and the right side of the region of interest 504, and horizontal line 514 may represent a halfway point between the top side of the region of interest 504 and the bottom side of the region of interest 504. Image capture device 100 may determine the locations of vertical line 512 and horizontal line 514 based on, for example, region of interest 504.

Image capture device 100 may further adjust region of interest 504 to generate adjusted region of interest 506 by reducing region of interest 504 along horizontal line 514 on either side of vertical line 512. In some examples, image capture device 100 reduces region of interest 504 along vertical line 512 on either side of horizontal line 514 by an equal amount.

Referring to FIG. 5C, in some examples, image capture device 100 may rotate adjusted region of interest 506 (e.g., clockwise, or counterclockwise) to conform to a pose of first person 502. For example, image capture device 100 may determine a pose angle 520 for face 510 of first person 502 (e.g., by executing face detection engine 144 described herein). The pose angle 520 may be measured, for example, from horizontal line 514. Image capture device 100 may rotate region of interest 506 based on the determined pose angle 520. For example, image capture device 100 may rotate the region of interest 506 by the pose angle 520. By rotating adjusted region of interest 506 in accordance with the pose angle 520 for face 510, image capture device 100 may cause a reduction in the number of pixels corresponding to background object, and increase the number of pixels corresponding to face 510, in the region of interest 506.

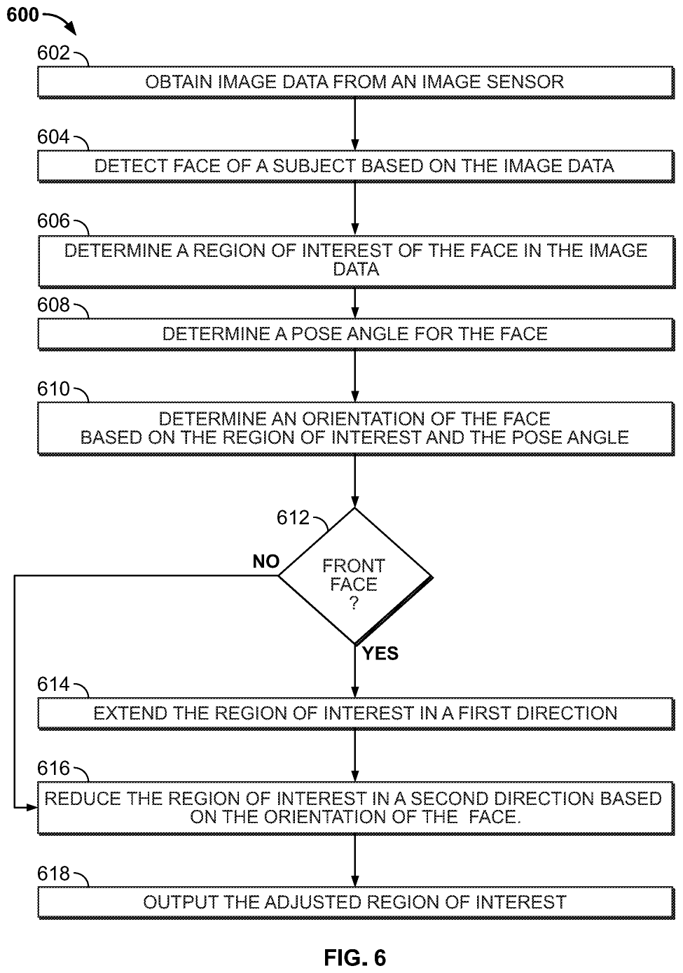

FIG. 6 is a flowchart of an example process 600 for computing an adjusted ROI within captured image data, in accordance with one implementation. Process 600 may be performed by one or more processors executing instructions locally at an image capture device, such as processor 160 of image capture device 100 of FIG. 1. Accordingly, the various operations of process 600 may be represented by executable instructions held in storage media of one or more computing platforms, such as storage medium 110 of image capture device 100.

Referring to block 602, image capture device 100 may obtain image data, such as image sensor data 165, from an image sensor, such as from camera optics and sensor 115. At block 604, image capture device 100 may detect a face of a subject based on the image data. For example, face detection engine 144 may perform one or more face detection processes to detect a face of a subject in image sensor data 165 obtained from camera optics and sensor 115. At block 606, the image capture device 100 may determine a ROI of the image data that includes the detected face, and face detection engine 144 may determine a ROI in image sensor data 165 that includes the detected face.

At block 608, image capture device 100 may determine a pose angle for the detected face. For example, face detection engine 144 may determine pose angle 207 of FIG. 2, which identifies a pose angle for the face within the determined ROI identified by face ROI location data 203.

In block 610, image capture device 100 may determine an orientation type of the face within the determined ROI based on, for example, captured image data within the ROI and a corresponding pose angle. For instance, face orientation detection engine 146 may obtain face ROI location data 203 and pose angle data 207, and determine an orientation type of the face within the ROI identified by face ROI location data 203 based on the pose angle identified by pose angle data 207.

At block 612, image capture device 100 may determine whether the orientation type of the face represents a front-facing orientation or a profile orientation. If the orientation type were to represent a front-facing orientation, method 600 proceeds to block 614, and the image capture device performs one or more of the exemplary processes describe herein to extend the ROI in a first direction. For example, executed face orientation detection engine 146 determines that the orientation type of the face represents a front-facing orientation, and executed first direction ROI adjustment engine 210 may extend the ROI in a vertical direction, as described herein. Method 600 may then proceed to block 616.

Alternatively, if, at block 612, the orientation type of the face does not represent a front-facing orientation (e.g., that the orientation represents a profile orientation), method 600 may proceed to block 616. At block 616, image capture device 100 may perform one or more of the exemplary processes described herein to reduce the ROI in a second direction based on the determined orientation type of the face. For example, executed second direction ROI adjustment engine 212 may reduce, in a horizontal direction, the ROI by a first amount when the face is disposed in a front-facing orientation, and may reduce the ROI by a second amount in the horizontal direction when the face is disposed in a profile orientation. In some examples, the first amount is less than the second amount.

At block 618, image capture device 100 generates output data that includes the adjusted ROI. In some examples, image capture device 100 may perform one or more of AF, AG, AE and AWB based on the adjusted ROI.

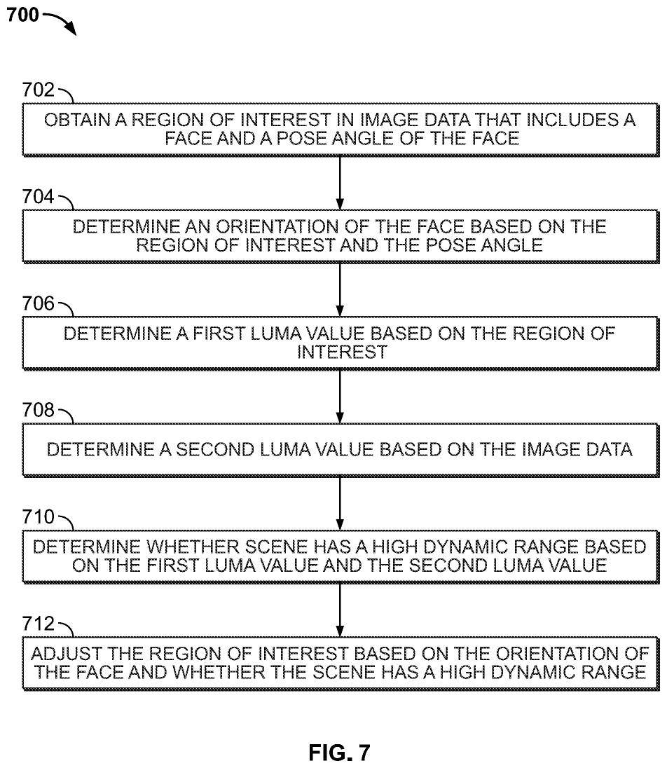

FIG. 7 is a flowchart of an example process 700 for adjusting a ROI within captured image data, in accordance with one implementation. Process 700 may be performed by one or more processors executing instructions locally at an image capture device, such as processor 160 of image capture device 100 of FIG. 1. Accordingly, the various operations of process 700 may be represented by executable instructions held in storage media of one or more computing platforms, such as storage medium 110 of image capture device 100.

At block 702, image capture device 100 may obtain data identifying a ROI and a pose angle of a face within captured image data. For example, executed image capture device 100 may obtain image sensor data 165 identifying a scene from camera optics and sensor 115, and executed face detection engine 144 may perform one or more face detection operations on image sensor data 165 to generate face ROI location data 203, which identifies a ROI that includes a face based on. Executed face detection engine 144 may also perform operations to generate pose angle data 207 identifying an angle of the face within the ROI.

At block 704, image capture device 100 may determine an orientation type of the face is determined based on the ROI and the pose angle. As an example, executed face orientation detection engine 146 may obtain face ROI location data 203 and pose angle data 207 from face detection engine 144. Executed face orientation detection engine 146 may also determine whether the pose angle identified by pose angle data 207 exceeds a threshold angle. For example, if the pose angle fails to exceed the threshold angle, face orientation detection engine 146 determines that the face is disposed in a front-facing orientation. Alternatively, if the pose angle is equivalent to or exceeds the threshold angle, face orientation detection engine 146 determines that the face is disposed in a profile orientation.

Proceeding to block 706, image capture device 100 may determine a first luma value based on the ROI. For example, executed luma detection engine 149 may determine a first average luminance value for all pixels within the ROI identified by face ROI location data 203, and generate face luma data 215 that includes the first average luminance value. At block 708, image capture device 100 determines a second luma value based on captured image data 165. For example, executed luma detection engine 149 may determine a second average luminance value for all pixels for the scene identified by image sensor data 165, and generate frame luma data 217 that includes the second average luminance value.

At block 710, image capture device 100 may determine whether the scene exhibits a high dynamic range based on the first luma value and the second luma value. For example, executed luma based dynamic range detection engine 151 may obtain face luma data 215 and frame luma data 217 from luma detection engine 149, and determine whether a scene represents a high dynamic range scene or a non-high dynamic range scene based on the luminance values identified by face luma data 215 and frame luma data 217. In some instances, luma based dynamic range detection engine 151 determines a ratio of the luminance values. Executed luma based dynamic range detection engine 151 may determine that the scene represents a high dynamic range scene when the determined ratio exceeds a ratio threshold. Alternatively, when the determined ratio fails to exceed the ratio threshold, luma based dynamic range detection engine 151 may determine that the scene represents a non-high dynamic range scene.

At block 712, image capture device 100 may perform operations that adjust the RO1 based on the orientation type of the face and whether the scene exhibits a high dynamic range or a low dynamic range. In some examples, when the orientation of the face corresponds to a front-facing orientation and the scene corresponds to a non-high dynamic range scene, executed first direction ROI adjustment engine 210 may extend the ROI in a first direction (e.g., the vertical direction described herein) by a first amount (e.g., by a number of pixels). For instance, executed first direction ROI adjustment engine 210 may extend a top edge and/or a bottom edge of the ROI by a same amount (e.g., by half of the first amount). In other examples, when the orientation corresponds to the front-facing orientation and the scene corresponds to a high dynamic range scene, executed first direction ROI adjustment engine 210 may extend the ROI in a first direction by a second amount. As described herein, the first amount may exceed than the second amount.

In further examples, executed first direction ROI adjustment engine 210 may not extend the ROI in the first direction when the face is deposed in the profile orientation. For instance, when the face is disposed in a profile orientation and the scene corresponds to a non-high dynamic range scene, executed first direction ROI adjustment engine 210 may extend the ROI in the first direction by a third amount. Alternatively, when the face is disposed in a profile orientation and the scene corresponds to a high dynamic range scene, executed first direction ROI adjustment engine 210 may extend the ROI in the first direction by a fourth amount. In some examples, the third amount exceeds the fourth amount.

Additionally, in some examples, and at block 712, executed ROI adjustment engine 212 may reduce the ROI in a second direction (e.g., the horizontal direction described herein) by a fifth amount when the face is disposed in a profile orientation and the scene corresponds to a non-high dynamic range scene. For example, executed second direction ROI adjustment engine 212 may reduce a left edge, and a right edge, of the ROI by a same amount (e.g., by half of the fifth amount). Alternatively, when the face is disposed in a profile orientation and the scene corresponds to a high dynamic range scene, executed first direction ROI adjustment engine 210 may reduce the ROI in the second direction by a sixth amount. The fifth amount may, in some instances, exceed the sixth amount.

In other examples, executed second direction ROI adjustment engine 212 may not reduce the ROI in the second direction at block 712 when the face is disposed in a front-facing orientation. For instance, when the face is disposed in a front-facing orientation and the scene corresponds to a non-high dynamic range scene, executed second direction ROI adjustment engine 212 may reduce the ROI in the second direction by a seventh amount. Further, when the face is disposed in a front-facing orientation and the scene corresponds to a high dynamic range scene, executed second direction ROI adjustment, engine 212 may reduce the ROI in the second direction by an eighth amount. The seventh amount may exceed the eighth amount in some examples.

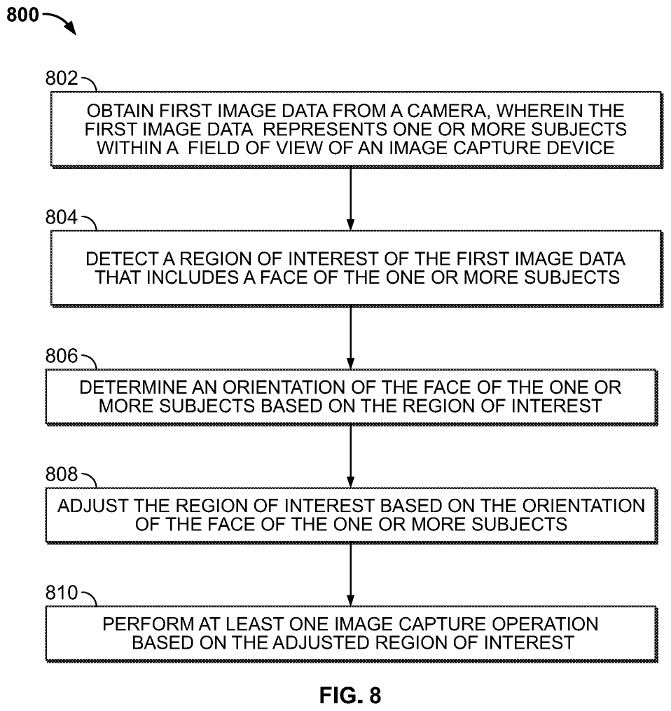

FIG. 8 is a flowchart of an example process 800 for performing at least one camera operation using an image capture device, in accordance with one implementation. Process 800 may be performed one or more processors executing instructions stored locally at an image capture device, such as processor 160 of image capture device 100 executing instructions maintained within storage medium 110.

At block 802, image capture device 100 may obtain first image data. For example, image capture device 100 may obtain the first image data from a camera. In some examples, the first image data may represent one or more subjects within a field of view of the image capture device. At block 804, image capture device 100 may detect a ROI of the first image data that includes a face of one or more subjects.

At block 806, image capture device 100 may determine an orientation type of the face of the one or more subjects based on the ROI. For example, image capture device 100 may determine a front-facing orientation, or a profile orientation, of the face of a subject based on the ROI. At block 808, image capture device 100 may adjust the ROI based on the orientation type of the face of the one or more subjects. At block 810, image capture device 100 may perform at least one image capture operation based on the adjusted ROI. For example, image capture device 100 may perform AF, AG, AE and AWB based on the adjusted ROI.

Although the methods described above are with reference to the illustrated flowcharts, many other ways of performing the acts associated with the methods may be used. For example, the order of some operations may be changed, and some embodiments may omit one or more of the operations described and/or include additional operations.

In addition, the methods and system described herein may be at least partially embodied in the form of computer-implemented processes and apparatus for practicing those processes. The disclosed methods may also be at least partially embodied in the form of tangible, non-transitory machine-readable storage media encoded with computer program code. For example, the methods may be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, computer program code segments configure the processor to create specific logic circuits. The methods may alternatively be at least partially embodied in application specific integrated circuits for performing the methods.

The subject matter has been described in terms of exemplary embodiments. Because they are only examples, the claimed inventions are not limited to these embodiments. Changes and modifications may be made without departing the spirit of the claimed subject matter. It is intended that the claims cover such changes and modifications.

We claim:

1. A method for operating an image capture device, comprising:
obtaining first image data, the first image data representing a subject within a field of view of the image capture device;
detecting a region of interest of the first image data that includes a face of the subject;
determining an orientation type of the face of the subject based on the region of interest;
adjusting the region of interest based on the orientation type of the face of the subject; and
performing at least one image capture operation based on the adjusted region of interest.

2. The method of claim 1 wherein performing the at least one image capture operation comprises performing at least one of automatic focus, automatic gain, automatic exposure, or automatic white balance using the adjusted region of interest.

3. The method of claim 2, wherein:
obtaining the first image data comprises obtaining the first image data from a camera; and
the method further comprises obtaining second image data from the camera based on the performance of the at least one of the automatic focus, automatic gain, automatic exposure, or automatic white balance.

4. The method of claim 1 comprising determining a pose angle of the face, wherein determining the orientation type of the face is based on the pose angle.

5. The method of claim 1 comprising detecting at least one facial feature of the face, wherein determining the orientation type of the face is based on the at least one facial feature.

6. The method of claim 1, wherein the orientation type of the face comprises a front-facing orientation or a profile orientation.

7. The method of claim 6, wherein adjusting the region of interest comprises extending the region of interest in a first direction when the orientation type of the face comprises the front-facing orientation.

8. The method of claim 7, wherein adjusting the region of interest comprises reducing the region of interest in a second direction when the orientation type of the face comprises the profile orientation.

9. The method of claim 1, further comprising:
determining a first value based on pixel values of the obtained first image data;
determining a second value based on pixel values within the region of interest; and
determining whether the first image data identifies a high dynamic range scene or a low dynamic range scene based on the first value and the second value,
wherein adjusting the region of interest comprises adjusting the region of interest based on the determination of whether the first image data identifies the high dynamic range scene or the low dynamic range scene.

10. The method of claim 9, wherein
the orientation type of the face comprises a front-facing orientation; and
adjusting the region of interest further comprises:
extending the region of interest in a first direction by a first amount when the orientation type of the face corresponds to the front-facing orientation and when the first image data identifies the low dynamic range scene; and
extending the region of interest in the first direction by a second amount when the orientation type of the face corresponds to the front-facing orientation and the first image data identifies the high dynamic range scene.

11. The method of claim 9, wherein:
the orientation type of the face comprises a profile orientation; and
adjusting the region of interest further comprises:
reducing the region of interest in a first direction by a first amount when the orientation type of the face corresponds to the profile orientation and the first image data identifies the high dynamic range scene; and
reducing the region of interest in the first direction by a second amount when the orientation type of the face corresponds to the profile orientation and the first image data does identifies the low dynamic range scene.

12. The method of claim 1, further comprising determining a state of a power configuration setting, wherein:
if the state of the power configuration setting corresponds to a first state, the method further comprises:
detecting at least one facial feature of the face of the subject; and
determining the orientation type of the face based on the at least one facial feature; and
if the state of the power configuration seating corresponds to a second state, the method further comprises:
determining a pose angle of the face of the subject; and
determining the orientation type of the face based on the pose angle.

13. An image capture device comprising:
a non-transitory, machine-readable storage medium storing instructions; and
at least one processor coupled to the non-transitory, machine-readable storage medium, the at least one processor being configured to execute the instructions to:
obtain first image data, the first image data representing a subject within a field of view of the image capture device;
detect a region of interest of the first image data that includes a face of the subject;
determine an orientation type of the ace of the subject based on the region of interest;
adjust the of interest based on the orientation type of the face of the subject; and
perform at least one image capture operation based on the adjusted region of interest.

14. The device of claim 13, wherein the at least one processor is further configured to execute the instructions to perform at least one of automatic focus, automatic gain, automatic exposure, or automatic white balance using the adjusted region of interest.

15. The device of claim 14 wherein the at least one processor is further configured to execute the instructions to:
obtain the first image data from a camera; and
obtain second image data from the camera based on the performance of the automatic focus, automatic gain, automatic exposure, or automatic white balance.

16. The device of claim 13, wherein the at least one processor is further configured to execute the instructions to:
determine a pose angle of the face; and
determine the orientation type of the face based on the pose angle.

17. The device of claim 13, wherein the least one processor is further configured to execute the instructions to:
detect at least one facial feature of the face; and
determine the orientation type of the face based on the at least one facial feature.

18. The device of claim 13 wherein is the orientation type of the face corresponds to a front-facing orientation or a profile orientation.

19. The device of claim 18, wherein the at least one processor is further configured to execute the instructions to extend the region of interest in a first direction when the orientation type of the face corresponds to the front-facing orientation.

20. The device of claim 19, wherein the at least one processor is further configured to execute the instructions to reduce the region of interest in a second direction when the orientation type of the face corresponds to the profile orientation.

21. The device of claim 13 wherein the at least one processor is further configured to execute the instructions to:
determine a first value based on pixel values of the obtained first image data;
determine a second value based on pixel values within the region of interest;
determine whether the first image data identifies a high dynamic range scene or a low dynamic range scene based on the first value and the second value; and
adjust the region of interest based on the determination whether the first image data identifies the high dynamic range scene or the low dynamic range scene.

22. The device of claim 21, wherein:
the orientation type of the face corresponds to a front-facing orientation; and
the at least one processor is further configured to execute the instructions to:
extend the region of interest in a first direction by a first amount when the orientation type of the face corresponds to the front-facing orientation and the first image data identifies the low dynamic range scene; and
extending the region of interest in the first direction by a second amount when the orientation type of the face corresponds to the front-facing orientation and the first image data identifies the low dynamic range scene.

23. The device of claim 21, wherein:
the orientation type of the face corresponds to a profile orientation; and
the at least one processor is further configured to execute the instructions to:
reducing the region of interest in a first direction by a first amount when the orientation type of the face corresponds to the profile orientation and the first image data identifies the high dynamic range scene; and
reducing the region of interest in the first direction by a second amount when the orientation type of the face corresponds to the profile orientation and the first image data identifies the low dynamic range scene.

24. The device of claim 13 wherein the at least one processor is further configured to execute the instructions to:
determine a state of a power configuration setting;
if the state of the power configuration setting corresponds to a first state, detect at least one facial feature of the face of the subject, and determine the orientation type of the face based on the at least one facial feature; and
if the state of the power configuration setting corresponds to a second state, determine a pose angle of the face of the subject, and determine the orientation type of the face based on the pose angle.

25. A non-transitory, machine-readable storage medium storing instructions that, when executed by at least one processor, cause the at least one processor to perform operations, comprising:
obtaining first image data, the first image data representing a subject within a field of view of an image capture device;
detecting a region of interest of the first image data that includes a face of the subject;
determining an orientation type of the face of the subject based on the region of interest;
adjusting the region of interest based on the orientation type of the face of the subject; and
performing at least one image capture operation based on the adjusted region of interest.

26. The non-transitory, machine-readable storage medium of claim 25 wherein performing the at least one image capture operation comprises performing at least one of automatic focus, automatic gain, automatic exposure, or automatic white balance using the adjusted region of interest.

27. The non-transitory, machine-readable storage medium of claim 26 wherein the instructions, when executed by the at least one processor, cause the at least one processor to perform further operations, comprising:
obtaining the first image data from a camera; and
obtaining second image data from the camera based on the performance of the automatic focus, automatic gain, automatic exposure, or automatic white balance.

28. A system for image capture comprising;
means for obtaining first image data, the first image data representing a subject within a field of view of an image capture device;
means for detecting a region of interest of the first image data that includes a face of the subject;
means for determining an orientation type of the face of the subject based on the region of interest;
means for adjusting the region of interest based on the orientation type of the face of the subject; and
means for performing at least one image capture operation based on the adjusted region of interest.

29. The system of claim 28, wherein the means for performing the at least one image capture operation comprises a means for performing at least one of automatic focus, automatic gain, automatic exposure, or automatic white balance using the adjusted region of interest.

30. The system of claim 29, wherein the first image data is obtained from a camera, and wherein the system further comprises a means for obtaining second image data from the camera based on the automatic focus, automatic gain, automatic exposure, or automatic white balance using the adjusted region of interest.
